(19) United States
(12) Patent Application Publication
(10) Pub. No.: US 2024/0428687 A1
(43) Pub. Date: Dec. 26, 2024

(54) INFORMATION PROCESSING APPARATUS, INFORMATION PROCESSING METHOD, AND PROGRAM

(71) Applicant: Nippon Telegraph and Telephone Corporation, Tokyo (JP)

(72) Inventors: Atsushi ISOMURA, Musashino-shi, Tokyo (JP); Nobuhiro OKI, Musashino-shi, Tokyo (JP); Ichibe NAITO, Musashino-shi, Tokyo (JP); Isoo UENO, Musashino-shi, Tokyo (JP); Naoko SHIGEMATSU, Musashino-shi, Tokyo (JP); Vlad DABIJA, Musashino-shi, Tokyo (JP)

(21) Appl. No.: 18/706,029

(22) PCT Filed: Mar. 29, 2022
(86) PCT No.: PCT/JP2022/015332

§ 371 Date: Apr. 30, 2024

Related U.S. Application Data
(60) Provisional application No. 63/277,931, filed on Nov. 10, 2021.

(51) Int. Cl. G08G 1/16; G06F 16/9537

(52) U.S. Cl. CPC G08G 1/16; G06F 16/9537

(57) ABSTRACT

An information processing device uses a spatiotemporal database in which information about objects on a road is continuously stored in association with time information and space information. The information processing device includes a search unit that searches the spatiotemporal database for information about trajectories of objects in a predetermined area, a prediction unit that predicts future paths of the objects on the basis of the information about the trajectories of the objects, a determination unit that determines whether there is a possibility that objects will collide on the basis of the future paths, and a notification unit that notifies the affected vehicles or the smartphones in a case where there is a possibility of collision.

### TECHNICAL FIELD

The present invention relates to an information processing device, an information processing method, and a program.

### BACKGROUND ART

It is said that a reaction time of a driver of an automobile is as long as about 0.7 seconds to 3 seconds, and even in a self-driving vehicle, the reaction time is as long as 0.5 seconds at the maximum. In addition, after a reaction such as braking or steering, the time until an effect such as significant deceleration, stopping, or change in trajectory is exerted may be considerably long depending on speed, performance parameters of the vehicle, characteristics of the traveling environment, and the like. As a result, it is very difficult to avoid unforeseen events that occur in a next very short period of time, and in many cases, accidents that have significant consequences in terms of both life and material costs occur. Patent Literature 1 to 4 and Non Patent Literature 1 and 2 disclose predicting an accident using sensing data of a sensor mounted on a vehicle.

On the other hand, Patent Literature 5 and Non Patent Literature 3 propose a high-speed spatiotemporal data management technology that searches for dynamic objects in a certain space in real time at a certain time while accumulating information transmitted by a large number of dynamic objects in the real space.

### CITATION LIST

### Patent Literature

Patent Literature 1: U.S. Pat. No. 7,613,569
Patent Literature 2: U.S. Pat. No. 7,566,231
Patent Literature 3: U.S. Pat. No. 5,541,590
Patent Literature 4: US 2006/162,985 A
Patent Literature 5: JP 2020-13539 A

### Non Patent Literature

Non Patent Literature 1: Saasha Nair, et al., “Monitoring Safety of Autonomous Vehicles with Crash Prediction Network”, AAAI 2019
Non Patent Literature 2: Matthew Sparkes, “Should we all wear sensors to avoid being run over by driverless cars?”, 2021 Mar. 5, NewScientist, Internet <URL:https://www.newscientist.com/article/2270282-should-we-all-wear-sensors-to-avoid-being-run-over-by-driverless-cars/>
Non Patent Literature 3: Kurayuki Hanadate and 8 others, “High-speed Spatiotemporal Data Management Technique” Axispot “and Spatiotemporal Data High-speed Search Technology”, NTT Technical Journal, Nippon Telegraph and Telephone Co., Ltd., November 2019, Vol. 31, No. 11. pp. 18-22

### SUMMARY OF INVENTION

### Technical Problem

The merit of an early response to an unexpected situation is high at the beginning and decreases over time. For example, decelerating a vehicle from 80 km/h to 60 km/h has greater merit than to decelerate the vehicle from 40 km/h to 20 km/h. Therefore, it is desirable to detect the possibility of collision earlier and notify the driver and the self-driving vehicle.

The present invention has been made in view of the above, and an object of the present invention is to detect an unexpected situation earlier and react more quickly.

### Solution to Problem

An information processing device according to an aspect of the present invention uses a spatiotemporal database in which information about objects on a road is continuously stored in association with time information and space information, and includes: a search unit configured to search the spatiotemporal database for information about trajectories of objects in a predetermined area; a prediction unit configured to predict future paths of the objects on the basis of the information about the trajectories of the objects; a determination unit configured to determine whether or not objects are likely to collide based on the future paths; and a notification unit configured to notify affected objects in a case where there is a possibility of collision.

An information processing method according to an aspect of the present invention uses a spatiotemporal database in which information about objects on a road is continuously stored in association with time information and space information, wherein, in the method, a computer searches the spatiotemporal database for information about trajectories of objects in a predetermined area, predicts future paths of the objects on the basis of the information about the trajectories of the objects, determines whether or not objects are likely to collide based on the future paths, and notifies affected objects in a case where there is a possibility of collision.

### Advantageous Effects of Invention

According to the present invention, it is possible to detect an unexpected situation more quickly and react more quickly.

### BRIEF DESCRIPTION OF DRAWINGS

FIG. 1 is a diagram illustrating an example of a configuration of a traffic management system of the present embodiment.

FIG. 2 is a flowchart illustrating an example of a flow of processing of the traffic management system.

FIG. 3 is a diagram illustrating another example of a configuration of a traffic management system of the present embodiment.

FIG. 4 is a flowchart illustrating an example of a flow of processing of a vehicle.

FIG. 5 is a diagram illustrating an example of a hardware configuration of an information processing device.

### DESCRIPTION OF EMBODIMENTS

Hereinafter, embodiments of the present invention will be described with reference to the drawings.

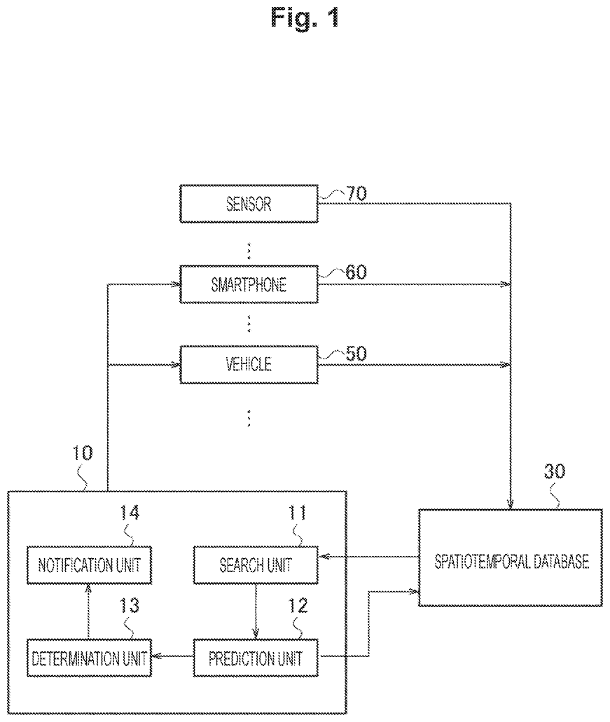

FIG. 1 is a diagram illustrating an example of a configuration of a traffic management system of the present embodiment. The system in the drawing includes an information processing device 10 and a spatiotemporal database 30, detects a potentially serious event (for example, a situation in which the possibility of collision is high), and notifies the objects (for example, a self-driving vehicle, a driver, a pedestrian, or the like) that will be affected by the event of the detected event.

The information processing device 10 searches the spatiotemporal database 30 for and acquires trajectory information up to the current time (for example, the most recent 3 to 5 seconds) of objects in a predetermined area such as a road or an intersection managed by the system, and, using the acquired information, predicts paths of the objects in the future from the current time (for example, in 0.5 seconds to 3 seconds). The information processing device 10 determines the possibility of a serious event on the basis of the predicted paths, and in a case where the possibility of occurrence of a serious event is high, notifies a vehicle 50, or a smartphone 60 held by a pedestrian that will affected by the event.

The spatiotemporal database 30 is a database that accumulates and searches for a data group associated with both time information and space information at high speed. As the spatiotemporal database 30, the spatiotemporal databases described in Patent Literature 5 and Non Patent Literature 3 can be used. For example, the spatiotemporal database 30 stores data and searches data by using a spatiotemporal code generated by extending a spatiotemporal code, in which space information is made one-dimensional, to a time domain as a key of a distributed key-value store (KVS). Assuming that the maximum value of time is 64 years, the maximum value of latitude is one circumference of the earth, and the maximum value of longitude is a semicircle of the earth, when the spatiotemporal code is composed of 36 bits of time, 30 bits of latitude, and 30 bits of longitude, it is possible to express a minimum rectangle of 30 ms×3 cm×3 cm square. By changing the length of the spatiotemporal code provided as a search condition, the range of time and space desired to be searched can be changed.

In the spatiotemporal database 30, information about a vehicle 50, a pedestrian holding a smartphone 60, or objects (moving and stationary objects such as vehicles, people, animals, balls, etc.) collected by sensors 70 placed to sense the area, is continuously collected and stored in association with time information and space information. The information about an object stored in association with the time information and the space information is, for example, the type of the object (vehicle, person, bicycle, ball, etc.), an identifier of the object, traveling direction, speed, acceleration, and the like. Information about a trajectory may be included in the information about the objects. The information about a trajectory is, for example, a trajectory (a collection of sets of time information and space information) of an object up to the time indicated by the associated time information. The information about an object may include a predicted path of the object predicted by the information processing device 10.

Information about objects detected by the vehicle 50, the smartphone 60, and the sensor 70 is stored in the spatiotemporal database 30. The vehicle 50 stores the information about the vehicle 50 in the spatiotemporal database 30 in association with the current time and the position information of the vehicle 50 itself. The vehicle 50 may store information about objects detected by a sensor provided in the vehicle 50 in the spatiotemporal database 30. The smartphone 60 stores pedestrian information in the spatiotemporal database 30 in association with the current time and position information of the smartphone 60. The sensor 70 stores the information of the detected objects in the spatiotemporal database 30 in association with the time information and the space information. For example, a security camera installed in a building can be used as the sensor 70.

The information processing device 10 in FIG. 1 includes a search unit 11, a prediction unit 12, a determination unit 13, and a notification unit 14.

The search unit 11 searches the spatiotemporal database 30 for information about the trajectories of objects existing in the predetermined area up to the current time. Specifically, the search unit 11 generates a spatiotemporal code using time information indicating a time desired to be searched and space information indicating a predetermined area, and searches the spatiotemporal database 30 for information about objects using the spatiotemporal code as a key. The search unit 11 searches the spatiotemporal database 30 for information about objects existing in the predetermined area while shifting the time information at intervals of several tens of milliseconds to several hundreds of milliseconds in the past from the current time, for example, and obtains information about the trajectory of the objects. In a case where the information about an object stored in the spatiotemporal database 30 in association with the time information and the space information includes information about the trajectory of the object up to the time indicated by the time information, the search unit 11 may acquire the information of the trajectory.

The search unit 11 may designate surroundings of a target vehicle 50 or a target pedestrian holding a smartphone 60 communicatively connected to the system as the predetermined area, and search the information about the trajectories of the objects around the target vehicle 50 or the target pedestrian from the spatiotemporal database 30.

The prediction unit 12 predicts a path of each object in the future from the current time by using the information about the trajectory of each object acquired from the spatiotemporal database 30. The predicted path is represented by, for example, a predicted position of the object at each time of several tens of milliseconds to several hundreds of milliseconds for 0.5 seconds to 3 seconds into the future.

The prediction unit 12 may store the predicted paths of the objects in the spatiotemporal database 30. For example, the prediction unit 12 includes the predicted paths in the information about the objects stored in association with the current time and the current position and stores the information in the spatiotemporal database 30. Alternatively, the prediction unit 12 may store time information indicating each future time and the space information indicating the predicted positions of the objects at that time in association with the information about the objects in the spatiotemporal database 30 as the predicted paths.

Note that, in a case where a predicted path of an object is stored in the spatiotemporal database 30, the prediction unit 12 may acquire the predicted path of the object from the spatiotemporal database 30 without calculating the predicted path. For example, in a case where the vehicle 50 stores a planned traveling route in the spatiotemporal database 30, the prediction unit 12 may use the planned traveling route stored in the spatiotemporal database 30 as the predicted path.

The prediction unit 12 detects a difference between the predicted position on the predicted path and the actual position of the object at that time, and recalculates the predicted path when the predicted path deviates.

The determination unit 13 determines whether or not a serious event (collision of objects) will occur in the predicted future on the basis of the predicted paths of the objects. For example, the determination unit 13 determines whether or not there are colliding objects at each point in time in the future at intervals of several tens of milliseconds. The possibility of collision of objects may be determined in a case where areas occupied by the objects overlap each other, or the possibility of collision of objects may be determined in a case where the distance between the objects is within a predetermined distance. For example, in a case where the predicted paths are stored in the spatiotemporal database 30, whether or not there is a possibility that a vehicle 50 will collide with an object can be determined by searching the spatiotemporal database 30 using a spatiotemporal code generated using time information indicating the future and space information indicating an area occupied by the vehicle 50 at that time as a key, and in a case where information of another object is obtained as a search result, it can be determined that there is a possibility that the vehicle 50 will collide with the object.

The notification unit 14 notifies objects that would be affected by a serious event, that a serious event may occur. Note that objects to be notified are vehicles 50, smartphones 60, or the like that can communicate with the system.

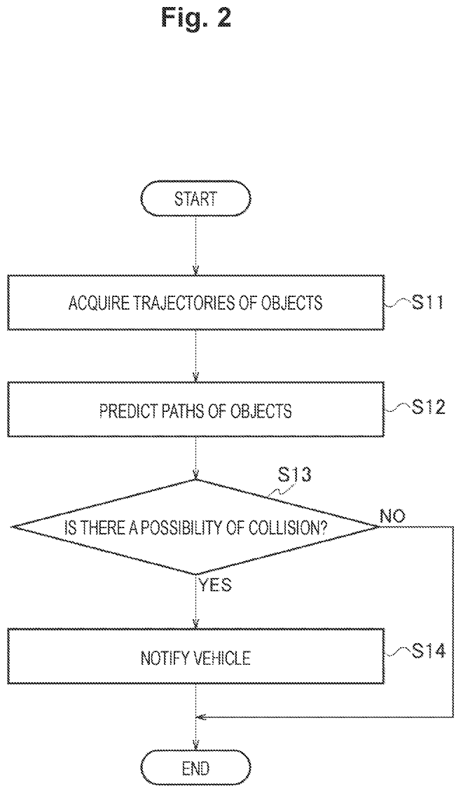

Next, an example of a flow of processing by the traffic management system will be described with reference to the flowchart in FIG. 2. It is assumed that information about objects detected from vehicles 50, smartphones 60, and sensors 70 is continuously stored in the spatiotemporal database 30. In addition, the processing illustrated in FIG. 2 is continuously executed by the information processing device 10.

In step S11, the information processing device 10 searches the spatiotemporal database 30 for information about the trajectories of the objects existing in the predetermined area up to the current time. The information processing device 10 may acquire information about the trajectories of the objects around a target vehicle 50 or a target pedestrian holding a smartphone 60 from the spatiotemporal database 30.

In step S12, the information processing device 10 predicts future paths of the objects using the information about the trajectories of the objects acquired from the spatiotemporal database 30.

In step S13, the information processing device 10 determines whether there is a possibility that objects will collide.

In a case where there is a possibility of collision, the information processing device 10, in step S14, notifies the vehicle 50 or the smartphone 60 of the possibility. In a case where the vehicle 50 is a self-driving vehicle or partially self-driving vehicle, the vehicle 50 may control the vehicle 50 based on the notification. Upon receiving the notification, the vehicle 50 may issue a warning to the driver.

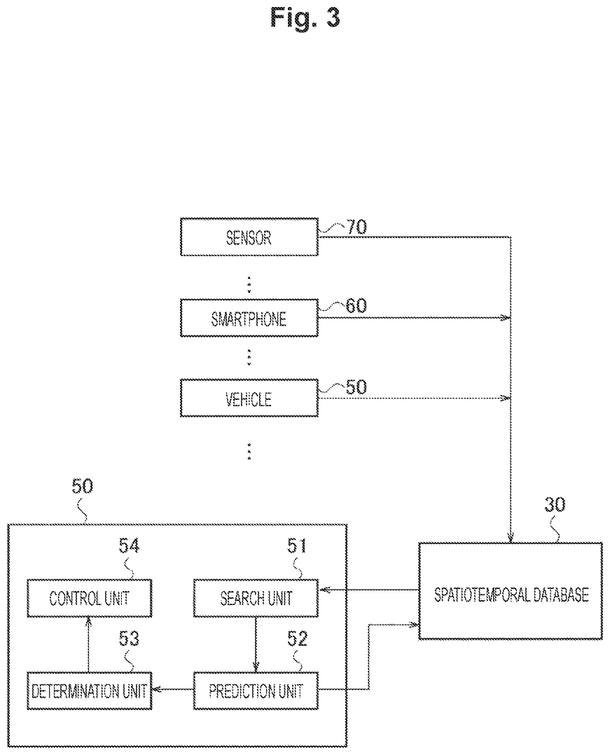

Next, an example in which the function of the information processing device 10 is provided in the vehicle 50 will be described with reference to FIG. 3.

The vehicle 50 illustrated in FIG. 3 includes a search unit 51, a prediction unit 52, a determination unit 53, and control unit 54. Note that the search unit 51, the prediction unit 52, and the determination unit 53 are similar to the search unit 11, the prediction unit 12, and the determination unit 53 of the information processing device 10.

The search unit 51 searches the spatiotemporal database 30 for information about the trajectories of objects existing in the predetermined area around the vehicle 50 up to the current time.

The prediction unit 52 predicts a path of each object in the future from the current time by using the information about the trajectory of each object acquired from the spatiotemporal database 30. In a case where the predicted path of an object is stored in the spatiotemporal database 30, the prediction unit 52 may acquire the predicted path of the object from the spatiotemporal database 30. The prediction unit 52 may store the predicted paths of the objects in the spatiotemporal database 30.

The determination unit 53 determines whether or not there is a possibility of collision with the vehicle 50 in the predicted future on the basis of the planned traveling route of the vehicle 50 and the predicted path of each object. For example, the determination unit 53 determines whether or not there is a colliding object at the position of the vehicle 50 at each point in time in the future at intervals of several tens of milliseconds.

The control unit 54 controls the vehicle 50 according to the determination result by the determination unit 53. For example, in a case where there is a possibility that the vehicle 50 and an object will collide with each other, braking is applied or a steering wheel is operated. The control unit 54 may notify the driver that there is a possibility of collision.

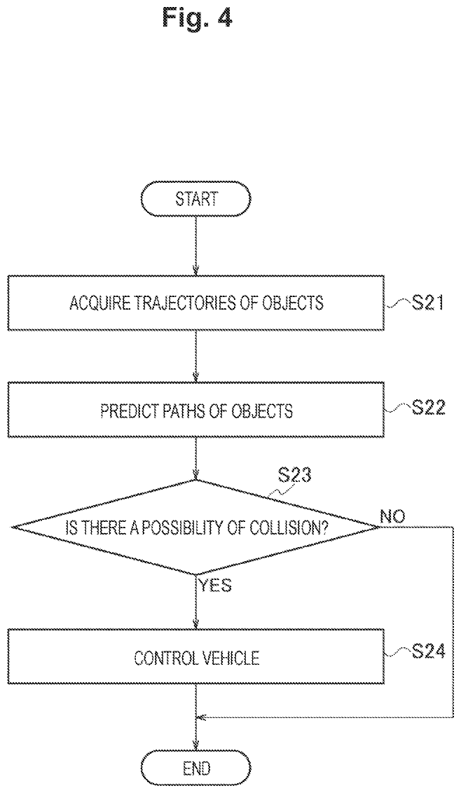

An example of a flow of processing performed by the vehicle 50 will be described with reference to a flowchart illustrated in FIG. 4. It is assumed that information about objects detected from vehicles 50, smartphones 60, and sensors 70 is continuously stored in the spatiotemporal database 30. In addition, the processing illustrated in FIG. 4 is continuously executed by the vehicle 50.

In step S21, the vehicle 50 searches the spatiotemporal database 30 for information about the trajectories of objects around the vehicle 50 up to the current time.

In step S22, the vehicle 50 predicts future paths of the objects using the information about the trajectories of the objects acquired from the spatiotemporal database 30.

In step S23, the vehicle 50 determines whether or not there is a possibility that the vehicle 50 will collide with an object.

In a case where there is a possibility of collision, the vehicle 50, in step S24, controls the vehicle 50 itself to avoid collision with the object or to reduce the impact of the collision. The vehicle 50 may issue a warning to the driver.

As described above, the information processing device 10 according to the present embodiment uses the spatiotemporal database 30 in which information about objects on a road is continuously stored in association with time information and space information. The information processing device 10 includes a search unit 11 that searches the spatiotemporal database 30 for information about trajectories of objects in a predetermined area, a prediction unit 12 that predicts future paths of the objects on the basis of the information about the trajectories of the objects, a determination unit 13 that determines whether there is a possibility that objects will collide on the basis of the future paths, and a notification unit 14 that notifies the affected vehicles 50 or the smartphones 60 in a case where there is a possibility of collision. In this manner, by predicting the paths of the objects on the basis of the data stored in the spatiotemporal database 30, determining a possibility of collision, and notifying a driver of a vehicle 50 or a pedestrian holding a smartphone 60, the driver and the pedestrian can quickly respond to an unexpected situation.

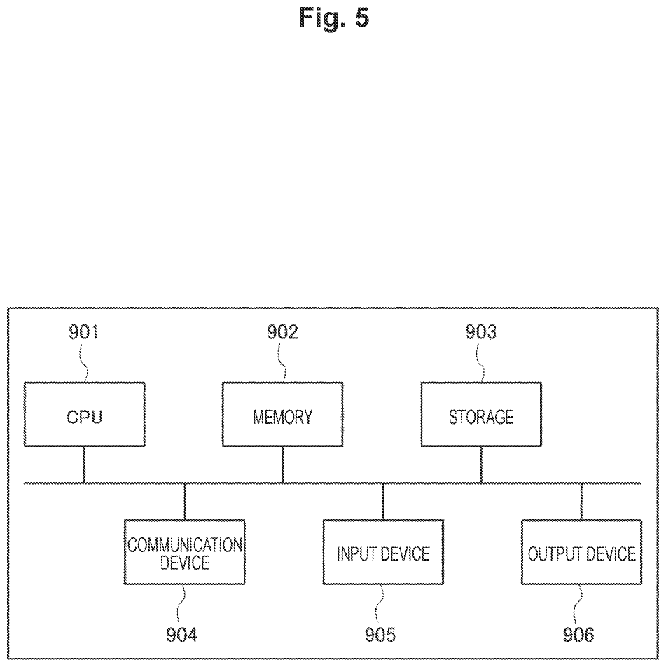

For example, as illustrated in FIG. 5, a general-purpose computer system including a central processing unit (CPU) 901, a memory 902, a storage 903, a communication device 904, an input device 905, and an output device 906 can be used as the information processing device 10 described above. In this computer system, the information processing device 10 is achieved by the CPU 901 executing a predetermined program loaded in the memory 902. This program can be recorded on a computer-readable recording medium such as a magnetic disk, an optical disc, or a semiconductor memory, or can be distributed via a network. This program may be installed in the vehicle 50 via a network, and the vehicle 50 may have the function of the information processing device 10.

Regarding the above embodiments, the following supplementary items are further disclosed.

### Supplement 1

An information processing device using a spatiotemporal database in which information about objects on a road is continuously stored in association with time information and space information, the information processing device including:
a memory, and at least one processor connected to the memory; wherein
the processor is configured to:
search the spatiotemporal database for information about trajectories of objects in a predetermined area;
predict future paths of the objects on the basis of the information about the trajectories of the objects;
determine whether or not objects are likely to collide based on the future paths; and
notify affected objects in a case where there is a possibility of collision.

### Supplement 2

A non-temporary storage medium that stores a program executable by a computer to execute information processing using a spatiotemporal database in which information about objects on a road is continuously stored in association with time information and space information;
the information processing
searches the spatiotemporal database for information about trajectories of objects in a predetermined area;
predicts future paths of the objects on the basis of the information about the trajectories of the objects;
determines whether or not objects are likely to collide based on the future paths; and
notifies affected objects in a case where there is a possibility of collision.

### REFERENCE SIGNS LIST

10 Information processing device
11 Search unit
12 Prediction unit
13 Determination unit
14 Notification unit
30 Spatiotemporal database
50 Vehicle
51 Search unit
52 Prediction unit
53 Determination unit
54 Control unit
60 Smartphone
70 Sensor

1. An information processing device using a spatiotemporal database in which information about objects on a road is continuously stored in association with time information and space information, the information processing device comprising:
a search unit, comprising one or more processors, configured to search the spatiotemporal database for information about trajectories of objects in a predetermined area;
a prediction unit comprising one or more processors, configured to predict future paths of the objects on the basis of the information about the trajectories of the objects;
a determination unit comprising one or more processors, configured to determine whether or not objects are likely to collide based on the future paths; and
a notification unit, comprising one or more processors, configured to notify affected objects in a case where there is a possibility of collision.

2. The information processing device according to claim 1, wherein in a case where a future path of an object is stored in the spatiotemporal database, the prediction unit is configured to acquire the future path from the spatiotemporal database.

3. The information processing device according to claim 1, wherein the search unit is configured to generate a spatiotemporal code using time information indicating a time desired to be searched and space information indicating a space desired to be searched, and search the spatiotemporal database using the generated spatiotemporal code as a key.

4. An information processing method using a spatiotemporal database in which information about objects on a road is continuously stored in association with time information and space information, wherein the method comprises:
searching the spatiotemporal database for information about trajectories of objects in a predetermined area;
predicting future paths of the objects on the basis of the information about the trajectories of the objects;
determining whether or not objects are likely to collide based on the future paths; and
notifying affected objects in a case where there is a possibility of collision.

5. The information processing method according to claim 4, further comprising acquiring the future path from the spatiotemporal database in a case where a future path of an object is stored in the spatiotemporal database.

6. The information processing method according to claim 4, further comprising generating a spatiotemporal code using time information indicating a time desired to be searched and space information indicating a space desired to be searched, and searching the spatiotemporal database using the generated spatiotemporal code as a key.

7. A non-transitory computer readable medium storing a program, wherein execution of the program causes a computer to operate as each unit of the information processing device according to claim 1.

8. A non-transitory computer readable medium storing a program installed in a terminal via a network, wherein execution of the program causes a computer to operate as each unit of the information processing device according to claim 1.
